(19) United States
(12) Patent Application Publication
(10) Pub. No.: US 2010/0142512 A1
(43) Pub. Date: Jun. 10, 2010

(54) METHOD AND ARRANGEMENT FOR AUTOMATICALLY UPDATING A WHITE LIST

(75) Inventors: Joachim Charzinski, Munchen (DE); Patrick Kleiner, Munchen (DE); Bernhard Kugle, Dasing (DE); Rita Leirich, Munchen (DE); Manuel Rieken, Wessling (DE)

Correspondence Address: K&L Gates LLP, P.O. BOX 1135, CHICAGO, IL, 60690, US

(73) Assignee: Nokia Siemens Networks GmbH & Co. KG, St.-Martin-Str. 76 (DE)

(21) Appl. No.: 12/063,565

(22) PCT Filed: Jul. 31, 2006
(86) PCT No.: PCT/EP06/64843

§ 371 Date: May 13, 2008

(30) Foreign Application Priority Data
Aug. 10, 2005 (DE) 102005037873.0

(51) Int. Cl. H04L 29/06; H04L 12/66; G06F 17/30

(52) U.S. Cl. 370/352; 726/3

(57) ABSTRACT

The invention relates to a method and a system and devices for session control in a communications network, whereby subscriber-specific data (D) of a subscriber (B) called by a calling subscriber (A) for the purpose of call completion (C) are stored in a list (WL), associated with the subscriber (A) to be called, for administering subscriber-specific data (D) of trustworthy subscribers. The subscriber-specific data (D) concerning the called subscriber (B) are automatically stored in the list (WL).

### CLAIM FOR PRIORITY

This application is a national stage application of PCT/EP2006/064843, filed Jul. 31, 2006, which claims the benefit of priority to German Application No. 10 2005 037 873.0, filed Aug. 10, 2005, the contents of which hereby incorporated by reference.

### TECHNICAL FIELD OF THE INVENTION

The invention relates to a method, arrangement and apparatuses for communication control in a communication network.

### BACKGROUND OF THE INVENTION

The term “spamming” denotes the bulk dispatch of unwanted messages (“spam”). “Spamming” is furthered by the simple and cheap access to electronic media, which normally allow messages to be sent to a large number of recipients with little time and cost involvement. The content of such “spam” messages is often of a commercial nature, with particularly “spam” of dubious content predominating. A well known form of “spam” is the bulk dispatch of e-mails for advertising purposes. Besides e-mail “spam”, there are other forms, such as “spam” for Instant Messaging, Usenet newsgroups, WWW search engines, weblogs or mobile radios.

As already mentioned, “spam” is furthered by the fact that the originators, for example advertisers, incur almost no effective costs by “spamming” apart from the management of appropriate e-mail address lists. Besides the obvious disadvantages which arise for the respective recipients as a result of the dispatch of unwanted messages, “spamming” now generates high costs which have to be borne by everybody. These are firstly indirect costs which arise as a result of loss of productivity or overfilled electronic mail boxes, for example. More serious, moreover, are the costs which are incurred for the respectively affected infrastructure providers, for example Internet service providers (ISPs): It is frequently necessary to increase bandwidth capacities, since the existing bandwidths are no longer sufficient to cope with the flood of “spam”.

Although “spamming” is ostracized by everybody, and the legal position in Germany and other countries is currently being adjusted, “spamming” is likely to increase further, since the obstacles to this type of message sending are very small.

With the increasing spread of Internet telephony (Voice over IP, VoIP for short), it is expected that VoIP subscribers will be exposed to what is known as SPIT (SPAM over Internet Telephony) to an increasing extent. At present, advertising calls to conventional PSTN subscribers (PSTN: Public Switched Telephone Network) are normally always charged to the caller. By contrast, calls to VoIP subscribers can be made almost at no cost to the caller on account of the different charging model, which means that a massive volume of SPIT is expected for the future. Particularly the opportunity to send recorded voice files in bulk ought to be of interest to advertisers. It can be assumed that the affected VoIP subscribers will demand that their respective VoIP provider takes suitable measures in order to be protected against unwanted calls.

As a measure to counteract SPIT, what are known as white lists are being used, inter alia. A white list contains subscriber-specific information for a subscriber A relating to other subscribers B in the communication network which have been classified as trustworthy and are therefore authorized to call subscriber A. Managing such lists using the telephone keypad or a web interface, for example, is relatively complex, however.

### SUMMARY OF THE INVENTION

The invention relates to a method, arrangement and apparatuses for simplified and improved management of white lists.

In one embodiment of the invention, there is a method for communication control in a communication network, according to which subscriber-specific data for a subscriber called by a calling subscriber for the purpose of setting up a communication link are included in a list, associated with the calling subscriber, for managing subscriber-specific data for trustworthy subscribers. In this context, the subscriber-specific data for the called subscriber are stored in the list automatically.

The invention also relates to an arrangement and apparatuses for carrying out the presented method.

The invention affords the advantage that managing and maintaining a list of subscriber-specific data for trustworthy subscribers are improved and simplified.

### BRIEF DESCRIPTION OF THE DRAWINGS

An exemplary embodiment of the invention is shown in the drawing and is described in more detail below. In the drawing, specifically:

FIG. 1 shows a schematic setup for a communication link.

### DETAILED DESCRIPTION OF THE INVENTION

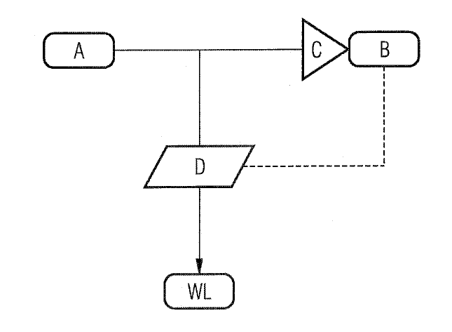

FIG. 1 shows the schematic setup for a communication link C and also the storage of the subscriber-specific data D. In the exemplary embodiment shown, a calling subscriber A sets up a communication link C to a called subscriber B. In one form of the invention, the communication link is a Voice-over-IP connection. In one exemplary embodiment, the subscriber-specific data D comprise the IP telephone number of subscriber B, for example. In line with the invention, subscriber-specific data D, for example the IP telephone number of the called subscriber B, are stored in the list WL automatically, that is to say without any action by the calling subscriber A, such as inputting the subscriber-specific data D on the terminal. In line with the invention, the actual storage location for the list WL is independent of the terminal of the calling subscriber A. In one advantageous form of the invention, the list WL is stored locally in the terminal of the calling subscriber A. Other options are storing the list WL at a switching node or in a database, for example. In this context, the subscriber-specific data D can optionally be stored in the list WL during setup of the communication link C, that is to say during the dialing process, for example, or while the communication link C exists or after the communication link C has been terminated.

In another form of the invention, the calling subscriber A can suppress storage of the subscriber-specific data D for a called subscriber B whose subscriber-specific data D are not intended to be stored in the list WL by dialing an additional code. The additional code can be dialed either before the communication link C is set up or after the communication link C has been terminated.

In another form of the invention, the list WL is managed in the form of a First-in-First-out list (FiFo list), the list WL having a stipulated maximum length, so that the respective subscriber-specific data D unused for the longest amount of time are deleted before entering new subscriber-specific data D, and are replaced by the new subscriber-specific data D, when the maximum length of the list WL has been exceeded. The maximum length of the list WL may in this case be preset by the calling subscriber A and/or by the network operator, for example.

In another form of the invention, if the list WL is being managed in the form of an FiFo list, a distinction is made between automatically stored and manually stored subscriber-specific data D, with only the automatically stored subscriber-specific data D being deleted when the maximum length of the list WL has been exceeded.

In another form of the invention, the automatic storage of subscriber-specific data D in the list WL can take place in the course of regular synchronization passes instead of storing the subscriber-specific data D in the list WL before or after setup of the communication link C or while the communication link C exists. In this case, the subscriber-specific data D stored, by way of example, in billing data or log files, for example IP telephone numbers of called subscribers B, are aligned with the entries in the list WL at regular intervals of time, for example once daily. If the IP telephone number of a called subscriber B does not appear in the list WL, this IP telephone number is stored in the list WL. Optionally, each entry in the list WL may include a time stamp, with the relevant time stamp for each IP telephone number of a called subscriber B which is called by subscriber A being updated in the appropriate entry in the list WL.

In another form of the invention, the list WL may be stored locally in a terminal belonging to the calling subscriber A.

In another form of the invention, the list WL may be stored in a soft switch in a convergent network.

In another form of the invention, the list WL may be stored in a circuit-switched TDM switch.

In another form of the invention, the list WL may be stored at least one circuit-switched and/or packet-switched switching node.

In this case, the list WL may have been split into list elements, with the respective list element being stored at a respective switching node. Optionally, the list elements may be disjunct relative to one another.

In another form of the invention, it is possible to transmit a list WL belonging to a calling subscriber A from one switching node to another switching node. This affords advantages particularly when the calling subscriber A changes operator, since in this case the list WL belonging to the calling subscriber A can also continue to be used.

In another form of the invention, the list WL may be stored in a database. In this case, the database may be stored on a central server. Optionally, a distributed architecture for the database is conceivable in which the database is split into elements and each database element is stored on a respective central or local server. In the case of a distributed database architecture, the list WL is maintained and updated using a log which, for example, when an IP telephone number has been dialed by the calling subscriber A, forwards the relevant IP telephone number to the server system which comprises at least one of the aforementioned servers. When the IP telephone number has been received, the server system stores it in a list WL.

1. A method for communication control in an Internet Protocol based communication network, comprising:
storing subscriber-specific data for a subscriber called by a calling subscriber for setting up a Voice-over-IP communication link in a list, associated with the calling subscriber, for managing subscriber-specific data for trustworthy subscribers; and
storing the subscriber-specific data for the called subscriber in the list automatically.

2. The method as claimed in claim 1, wherein the calling subscriber uses a first additional code to prevent automatic storage of the subscriber-specific data for the called subscriber in the list.

3. The method as claimed in claim 1, wherein following the termination of the communication link the calling subscriber is allowed to delete the subscriber-specific data for the called subscriber from the list by using a second additional code.

4. The method as claimed in claim 1, wherein the automatic storage of subscriber-specific data takes place in the course of regular synchronization passes, with subscriber-specific data from subscribers called by the calling subscriber in a stipulated period being aligned with the list and, if they are not present in the list, being stored in the list.

5. The method as claimed in claim 1, wherein the list is edited manually by the calling subscriber.

6. An arrangement for communication control in an Internet Protocol based communication network, comprising at least one device for automatically storing subscriber-specific data for a subscriber called by a calling subscriber for setting up a Voice-over-IP communication link in a list, associated with the calling subscriber, of subscriber-specific data for trustworthy subscribers.

7. The arrangement as claimed in claim 6, wherein the list of subscriber-specific data for trustworthy subscribers is stored locally in a terminal belonging to the calling subscriber.

8. The arrangement as claimed in claim 6, wherein the list of subscriber-specific data for trustworthy subscribers is stored at at least one switching node.

9. The arrangement as claimed in claim 6, wherein the list of subscriber-specific data for trustworthy subscribers is stored in a database.

10. A terminal, comprising at least one device for automatically storing subscriber-specific data for a subscriber called by a calling subscriber for setting up a Voice-over-IP communication link in a list, associated with the calling subscriber, of subscriber-specific data for trustworthy subscribers.

11. A switching node, comprising at least one device for automatically storing subscriber-specific data for a subscriber called by a calling subscriber for setting up a Voice-over-IP communication link in a list, associated with the calling subscriber, of subscriber-specific data for trustworthy subscribers.

12. A server system, comprising at least one device for automatically storing subscriber-specific data for a subscriber called by a calling subscriber for setting up a Voice-over-IP communication link in a list, associated with the calling subscriber, of subscriber-specific data for trustworthy subscribers.
